(19) United States
(12) Patent Application Publication
(10) Pub. No.: US 2010/0232591 A1
(43) Pub. Date: Sep. 16, 2010

(54) Electronic telephone directory system

(75) Inventors: Rodney Valentine, Silver Spring, MD (US); Laplie Anderson, East Boston, MA (US); Jonathan Sutton, Silver Spring, MD (US)

Correspondence Address: Rodney Valentine, Apt 612, 1705 East-West Hwy, Silver Spring, MD, 20910, US

(73) Assignee: VAS Concepts, LLC, Silver Spring, MD (US)

(21) Appl. No.: 12/382,284

(22) Filed: Mar. 12, 2009

(51) Int. Cl. H04M 3/42

(52) U.S. Cl. 379/218.01

(57) ABSTRACT

An electronic telephone directory system is described. Each entry in the directory has summary information, category specific information, and associated categories. The system displays a different view of the category specific information depending on categories associated with an entry. For example, a restaurant may have a detailed view that shows its menu and specials whereas the detailed view for a taxi service shows the company's coverage area. The directory periodically updates using cellular networks but generally operates without an active network connection.

### BACKGROUND OF THE INVENTION

1. Field of the Invention

This application relates to telephone directories. More specifically, the present inventions relates to a system to distribute and to view electronic telephone directories.

2. Background Information

Summary information for a business or individual is the business or individual's name, address, and telephone number.

Businesses can belong to any number of business categories. A category is a grouping of similar businesses based on the products or services that the grouped businesses offer.

Category specific information is extra information about a business that is only relevant and applicable because the business belongs to a specific business category. For example, the category specific information for businesses belonging to a ‘restaurant’ category could be the business' menus. The concept of a food menu is only relevant for businesses that belongs to the ‘restaurant’ category, thus a menu is category specific information for restaurants. A business can have category specific information for all of the categories in which it belongs. A business that delivers food might belong to the ‘restaurant’ and ‘delivery service’ categories and would have category specific information related to each.

Both businesses and consumers have an interest in the cheap distribution of accurate and current summary information and category specific information. Consumers use summary information and category specific information for a variety of purposes. They use the information to find out how to contact a business or individual, to find what products a business offers, and to find which businesses best fit their needs. Businesses rely on category specific information and summary information to be distributed to potential customers so that customers are aware of their products and how to obtain them.

Previously, summary information was distributed in the form of large telephone directory books delivered to subscribers. This form of distribution has many disadvantages. The printing and physical transportation of the books to subscribers create a financial and logistical burden for the distributor: delivering large heavy books to millions of subscribers is expensive and time consuming. For subscribers, the situation is not ideal either. By the time phone directories reach subscribers, they are already out-of-date. In the time taken for the books to be printed, packaged, and delivered, new numbers may have been assigned, phone numbers could have changed, and businesses may have changed addresses. Even worse, many directory publishers only print and distribute new directories annually because of great production costs. Likewise, the energy used to print and to distribute the directories in conjunction with the trees milled for the paper used by the books creates an environmental stress to the detriment of subscriber and distributor alike.

Traditional telephone directories usually contain summary information about businesses and individuals. The directories also group and print businesses together by category. The downside of this way of grouping is that a business can only be printed in a single category. This fact greatly reduces the granularity and expressiveness of belonging to a category and limits the effectiveness of a subscriber looking for a business. When searching for a business, a subscriber must predict where the business was printed. A business printed in one of its less important categories may never be found by people searching for it in a different category.

Traditional directories do not publish category specific information. Those businesses having category specific information must use another way of getting that information to patrons. Typically, this alternate information distribution takes the form of paper delivery in a non-unified (across businesses and business categories) and haphazard manner. Some businesses may hire delivery personnel to distribute their category specific information in the form of circulars and flyers. Other business may rely on patrons passing their window display to see their products and current promotions. There are many inefficiencies in this non-unified distribution system that could be reduced or eliminated if a uniform distribution system were adopted.

More recently, the Internet has made it easier for consumers to find information on demand. There are websites dedicated to providing telephone directory information and others websites for looking up category specific information. However, searching the Internet becomes a task in itself. Rather than finding all the needed information in a single place, one might have to search one website, for example, to find restaurants in a neighborhood, another site to find a specific restaurant's menu, and maybe a third to find the telephone number for the restaurant. The various pieces of summary and category specific information are not combined as a cohesive unit. The Internet puts more burdens on the user by forcing the user to locate these various pieces of information over varied and sparse sources.

Using the Internet also requires an active network connection. The Internet becomes completely useless outside of a relatively small portion of the globe where a wireless or wired network connection is available. The telephone directory system described in U.S. Pat. No. 5,483,586 to Sussman aimed to solve the connectivity problem by having a directory that is periodically updated from a central database. However, that system only provided summary information. That system did not provide category specific information for a business. Therefore, in order to get a full picture of a business, a user of that system must still resort to using some other source of information.

Without category specific information, the utility provided by a telephone directory system is greatly reduced. Knowing summary information about an entity is a very small part of what a user of an ideal system would want. Users may also want to know the delivery range of a furniture store, the current sales of an electronic store, and the ingredients of a restaurant's appetizer. All of these details and many more would only be available as category specific information.

In view of the above, it will be apparent to those skilled in the art from this disclosure that there exists a need for an improved electronic telephone directory system. This invention addresses this need in the art as well as other needs, which will become apparent to those skilled in the art from this disclosure.

### SUMMARY OF THE INVENTION

An electronic telephone directory system according to the present invention includes a plurality of telephone number entries in which each entry is linked to a plurality of information, a local memory containing the entries, a communication device to retrieve remote instructions, entry addition instructions, and entry removal instructions from a remote system, a processor that applies the instructions to the local memory, a plurality of templates wherein each template is configured to transform information linked to one or more of said entries into a form suitable for rendering, an input device to select an entry from the local memory, a second processor to select an appropriate template from the templates and to apply it to the selected entry to produce a rendered form, a display to show the rendered form to a user of the system.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a block diagram showing principal components of a device of a directory system and their interconnections in accordance with a first preferred embodiment of the present invention;

FIG. 2 is a view of an object relational diagram for objects stored in a memory of the device of the directory system;

FIG. 3 is a view of a flowchart showing a general workflow diagram for a user of the device of the directory system;

FIG. 4 is a view of a flowchart showing the steps to produce a detailed view on the device from a selected entry;

FIG. 5 is a view of a flowchart showing the steps to initiate a call from the device;

FIG. 6 is a view of a flowchart showing the steps in a general network architecture of the directory system to connect the device to a remote server for updates;

FIG. 7 is a view of a schematic diagram showing the components of the directory system to perform a database update from a remote server; and

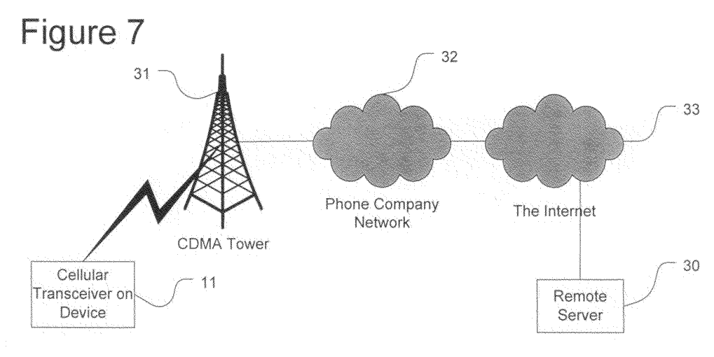

FIG. 8 is a view of a relationship between an example entity, its category specific information, and the rendered views of its category specific information.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Memory

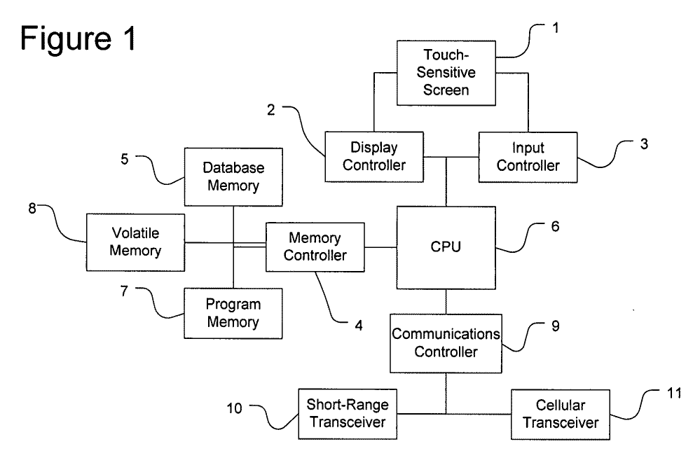

Referring to FIG. 1, a CPU 6 is connected to a memory controller 4. The memory controller 4 is connected to a database memory 5, program memory 7, and volatile memory 8. In this embodiment, the memory controller 4 arbitrates access between the CPU 6 and the various memory components. In another possible embodiment, the CPU 6 may connect to memory directly without the need for a memory controller.

The program memory 7 stores the executable processor instructions for device operation. In one embodiment, these processor instructions may detail operations for displaying a user interface on the screen, responding to user input, and interfacing the CPU 6 with other components in the device. The contents of the program memory 7 are recoverable after a loss of power or a shutdown of the device. The program memory 7 can be a hard disk. Alternatively the program memory 7 can be a ROM chip.

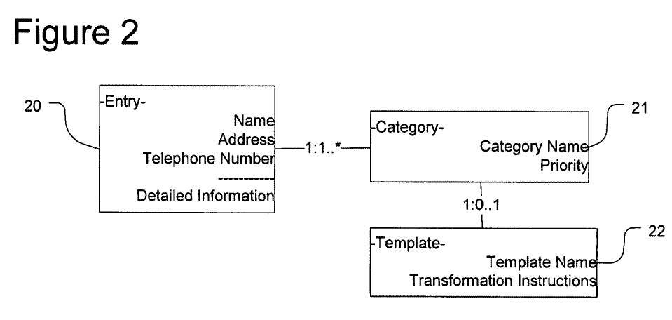

The database memory 5 stores templates, entries, and categories. The relationship between entries, categories, and templates is shown in FIG. 2. In this embodiment, an entry 20 contains summary information (name, address, telephone number) and category specific information of a real-life entity. A category 21 has a category name and a priority. A template 22 has a template name and transformation instructions.

The database memory 5 is usually updated periodically from a remote system. The contents of the database memory 5 are recoverable after a loss of power or a shutdown of the device. The database memory 5 can be a hard disk.

The volatile memory 8 is used by the CPU 6 as temporary storage space during operation. In this embodiment, the volatile memory 8 is preferably RAM.

In this embodiment, the database memory 5, the program memory 7, and volatile memory 8 are preferably three separate physical components. Another possible embodiment could have the duties of the three memory types performed by less physical components or more physical components.

### Communications

The CPU 6 is connected to a communications controller 9. The communications controller 9 is connected to a short range transceiver 10 and cellular transceiver 11. In this embodiment, the communications controller 9 arbitrates access between the CPU 6 and the various transceivers. In another possible embodiment, the CPU 6 may connect to the transceivers directly.

In this embodiment, the cellular transceiver 11 is preferably a CDMA radio. The cellular transceiver 11 is configured to communicate via CDMA based cellular networks to remote systems to receive update instructions. In another possible embodiment, the cellular transceiver 11 could be replaced by another type of radio such as a GPRS radio (i.e., a radio configured to communicate with GPRS based cellular networks). This alternate embodiment would be advantageous if the GPRS based cellular network offered better service in terms of cost or signal quality.

The short range transceiver 10 of this embodiment is preferably a BLUETOOTH™ (short distance wireless) radio. The short-range transceiver is configured to communicate with various BLUETOOTH™ enabled devices up to an approximate range of 32 feet.

Both transceivers of this embodiment are of a wireless nature. In an alternate embodiment, the function of the transceivers could be accomplished through a wired means such as Ethernet or USB. The advantage of an embodiment using wired transceivers would be that the system would be less susceptible to interference and variations in signal strength. The disadvantages of a wired system would be that it limits the portability of the device.

### User Input and Output

The CPU 6 is connected to a display controller 2 and an input controller 3. Both the display controller 2 and input controller 3 are connected to a touch-sensitive screen 1. The CPU 6 uses the display controller 2 to control what is displayed on the screen. The CPU 6 receives user input from the touch-sensitive screen 1 via the input controller 3. In an alternate embodiment, the duties of display and input could be realized by more than one distinct device. For example, the touch-sensitive screen 1 in this embodiment could be replaced by a combination of a screen, a keyboard, and a mouse.

### Operation

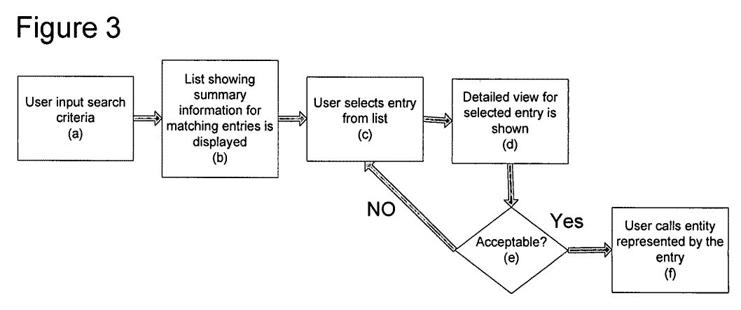

A workflow for a user of the device is shown in FIG. 3. A user inputs some search criteria (a) and gets a list of related entries (b). The user then selects an entry (c) and the device shows a detail view of that entry (d). If the user is happy with the information shown in the detail view (e), the user has the option to place a call to the entry's associated telephone number (f). If the user does not find the entry acceptable, he or she may select another entry (c). Each of these steps is explained further in further sections.

### Searching for an Entry

One use of the system includes a user searching for a particular entry based on partial knowledge and the system showing a list of possible matches. To search, the system checks each entry in the database against the search criteria that the user enters. Each matching entry is added to a list that is displayed to the user. The user then has the option of selecting an entry for a detailed view.

### Showing a Detailed View of an Entry

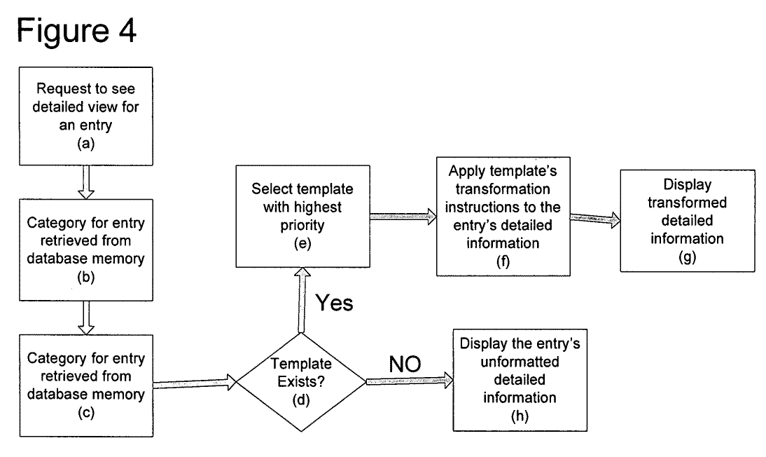

After the user selects an entry for display, the detail view of the selected entry is displayed on the screen. The steps the system takes to accomplish this task is shown in FIG. 4. To show the detail view, the system firsts retrieve the appropriate template from the database memory 5 and then applies it to the selected entry.

Each template has transformation instructions detailing how to apply the template to the entry. A coverage-area template might have instructions for transforming a business location and radius into a map with a circle overlay. A restaurant template might have instructions for transforming a list of restaurant dishes into an interactive menu. The transformation instructions a template contains are specific the intended target of the template.

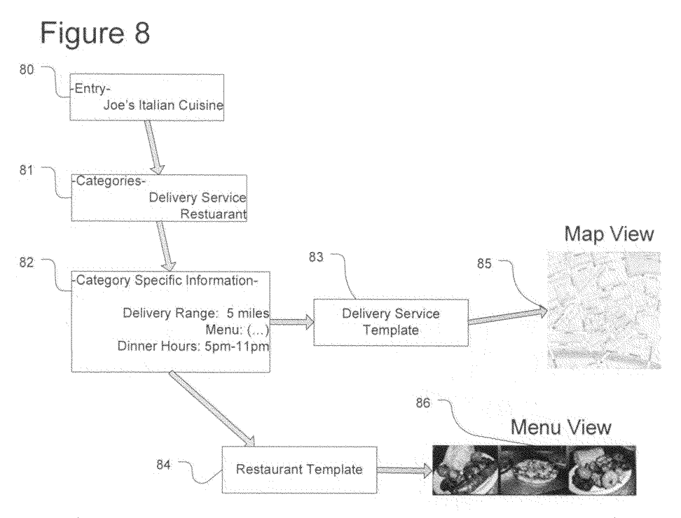

An example entity and possible categories is shown in FIG. 8. In this example, category specific information 82 is transformed into detail view 85, a map view, and detail view 86, a menu view, by template 83 and template 84. In this example, template 83 and template 84 are associated with the example entry's categories so their transformation instructions were applied.

If an entry has more than one template, the template with the highest priority could be applied, or multiple templates could be applied. If an entry does not have an applicable template, the category specific information for the entry is displayed in an unformatted/raw form.

### Initiating a Call

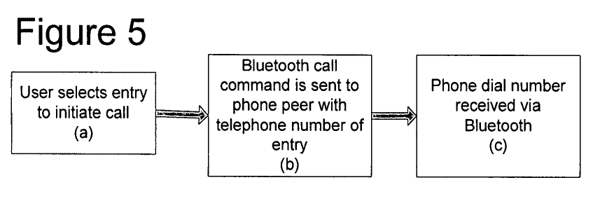

In this embodiment, the system can connect to BLUETOOTH™ devices. When a phone is connected via a BLUETOOTH™ device, the user may select an entry on the device and have the connected phone dial the telephone number associated with the entry. FIG. 5 shows the steps to initiate a call from the system.

### Retrieving Updates

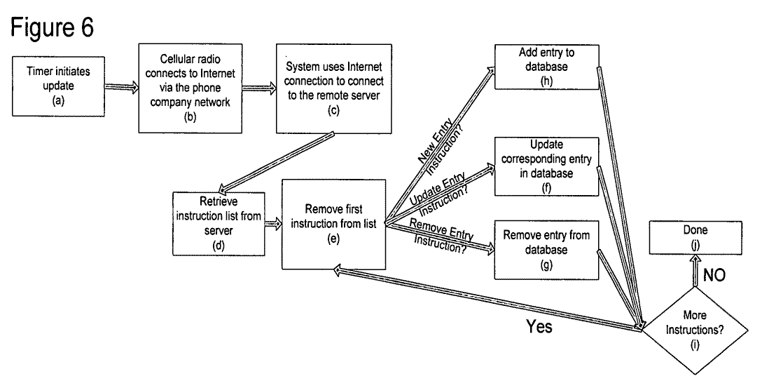

Periodically, the system connects to a remote server 30 and retrieves instructions to update its local database. In this embodiment, the system connects to the remote system using a network topology as shown or similar to the one shown in FIG. 6. The cellular transceiver 11 connects wirelessly to the nearest CDMA tower 31. The CDMA tower 31 is connected to a phone company network 32 which is in turn connected to the Internet 33. The remote server 30 also connects to the Internet 33 completing the loop. In another possible embodiment, the Internet 33 could be bypassed if the remote server 30 can connect to the phone company network 32 directly.

The steps necessary to perform a database update are shown FIG. 6. When a timer initiates an update cycle, the cellular radio connects to the Internet 33 via the phone company network 32. The system then connects to the remote server 30 using the infrastructure of the Internet 33 and retrieves a list of instructions from the remote server 30.

Each instruction type has a specific action to take when applying the instruction to the database. The system loops over each instruction in the list of retrieved instructions and performs the relevant action.

### Conclusion, Ramifications, and Scope

It should be apparent from this disclosure that the telephone directory system of the present invention provides telephone directory distributors with a more cost effective and easier way to provide accurate and current directories to subscribers. It also provides a mechanism for businesses to distribute category specific information related to all of the business categories to which they belong. At least one embodiment of the telephone directory system is an incredible boon for the environment by greatly reducing the energy costs and deforestation externalities associated with printing and distributing paper backed information.

For users, at least one embodiment of the telephone directory system allows the users to view up-to-date summary and category specific information. It allows users to easily search for businesses using varied criteria. The device shows category specific information in a view that is specific to the type of category specific information. Specific detail views and conglomeration provide great value added to users because a lot of the work associated with finding information about an entity is already done for them.

While the above description contains much specificity, these should not be construed as limitations on the scope of any embodiment, but as exemplifications of the presently preferred embodiments thereof. Many other ramifications and variations are possible within the teachings of the various embodiments.

Thus the scope should be determined by the appended claims and their legal equivalents, and not by the examples given.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having,” and their derivatives. Also, the terms “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An electronic telephone directory system comprising:
a plurality of telephone number entries, each entry being linked to a plurality of information selected from the group consisting of summary information, category specific information, and categorical information;
a local memory containing the entries;
a communication device being configured to retrieve remote instructions selected from the group consisting of entry modification instructions, entry addition instructions, and entry removal instructions from a remote system;
a first processing device being configured to apply the instructions to the local memory
a plurality of templates, each template being configured to transform information linked to one or more of the entries into a form suitable to render;
an input device being configured to select an entry from the local memory;
a second processing device being configured to select an appropriate template from the templates and to apply it to the selected entry to produce a rendered form;
a display being configured to display the rendered form to a user of the system.

2. The system in accordance with claim 1, wherein a subset of the telephone number entries is associated with individuals and the linked information of the individual associated entries contains the name of an associated individual.

3. The system in accordance with claim 1, wherein a subset of the telephone number entries is associated with businesses and the linked information of the business association entries contains the name of an associated business.

4. The system in accordance with claim 1, wherein the display of entries is filtered or sorted by search criteria matched against linked information of the entries.

5. The system in accordance with claim 4, wherein the results of the search is sorted by geographic distance from the location of the system.

6. The system in accordance with claim 1, wherein a subset of the linked information of the entries contains an address corresponding to the selected entry.

7. The system in accordance with claim 5, wherein the results of the search is sorted by geographic distance from the location of the system.

8. The system in accordance with claim 6, wherein a subset of the templates is configured to transform the address into a map view of the address.

9. The system in accordance with claim 1, wherein the second processing device selects an appropriate template for the selected entry based upon the categorical information of the selected entry.

10. The system in accordance with claim 9, wherein the selected entry is linked to a restaurant category and the category specific information contains a restaurant menu.

11. The system in accordance with claim 1, wherein the communication device uses the Internet as a medium for instruction transport.

12. The system in accordance with claim 1, further comprising
an interface to connect a telephone to the system, and
an invocation device to cause the connected telephone to dial the telephone number of the selected entry.

13. The system in accordance with claim 12, wherein the interface uses short distance wireless technology.

14. The system in accordance with claim 1, wherein the display and the input device are the same component.

15. The system in accordance with claim 1, wherein entries are selected and displayed automatically without a user interaction with the input means.

16. The system in accordance with claim 15, wherein category specific information is in the form of advertisements.

17. The system in accordance with claim 15, wherein the automatically selected entries are based on previous searches conducted on the system.

18. The system in accordance with claim 1, wherein entries may be saved for later retrieval.

19. The system in accordance with claim 18, wherein saved entries are associated with an expiration date.

20. The system in accordance with claim 19, wherein the plurality of templates contains a template to transform the saved entries into a calendar rendering showing expiration date for each saved entry.
